(19) United States
(12) Patent Application Publication
(10) Pub. No.: US 2024/0353346 A1
(43) Pub. Date: Oct. 24, 2024

(54) SYSTEM AND METHOD FOR THREE-DIMENSIONAL LASER SCANNING WITH OPTICAL POSITION SENSING

(71) Applicant: PLX, Inc., Deer Park, NY (US)

(72) Inventors: Itai Vishnia, Setauket, NY (US); Malcolm Humphrey, Hicksville, NY (US); Martin Rost, Islip Terrace, NY (US)

(21) Appl. No.: 18/640,251

(22) Filed: Apr. 19, 2024

Related U.S. Application Data
(60) Provisional application No. 63/497,229, filed on Apr. 20, 2023.

(51) Int. Cl. G01N 21/88; G01N 21/64

(52) U.S. Cl. CPC G01N 21/8851; G01N 21/8806; G01N 2021/6463

(57) ABSTRACT

A system and method for orthogonal laser metrology having one or more orthogonal laser metrology modules (O-LAMMs). The system includes a first monolithic structure that includes a first plurality of components preinstalled and aligned in the first monolithic structure, at least one of the first plurality of components comprising a bidirectional beam steering device; and a second monolithic structure that includes a second plurality of components preinstalled and aligned in the second monolithic structure. The first monolithic structure has a first connecting portion; the second monolithic structure has a second connecting portion; the first monolithic structure and the second monolithic structure are each constructed to be aligned and adjoined to each other at an interface of the first connecting portion and the second connecting portion; and the first plurality of components are preinstalled and optically aligned in the first monolithic structure such that when the first monolithic structure and the second monolithic structures are adjoined to each other at said interface, the second plurality of components are aligned with the first plurality of components.

### CROSS REFERENCE TO RELATED APPLICATIONS

This application is entitled to and hereby claims priority under 35 U.S.C. § 119 (e) to provisional U.S. patent application, Ser. No. 63/497,229, filed Apr. 20, 2023, titled, “System and Method for Three-Dimensional Laser Scanning with Optical Position Sensing,” which is hereby incorporated herein in its entirety.

### TECHNICAL FIELD

The present disclosure relates generally to optics, electronics, laser technology and computer program code for metrology, and more particularly to a device, a method, and a system for implementing orthogonal laser metrology for detection, measurement, monitoring, identifying or tracking, including, but not limited to, size, shape, orientation, location or motion of an object, a surface or a target in multidimensional space.

### BACKGROUND

State-of-the-art industrial metrology applications typically use photogrammetry or laser tracker technologies. Photogrammetry technologies commonly use two or more video cameras with a known distance between the cameras. The cameras are used to image a series of retroreflectors that are placed on targets within the scene. These are coded such that a computer-implemented methodology can distinguish the identity of each reflective target. Each image is processed to identify the center of each reflector within the image. This is then converted to an X/Y angle for each reflector. By triangulating with the data from the second camera, the position of each reflector can be determined.

Laser tracker technologies, on the other hand, typically use a mechanically steered precision laser rangefinder with interferometry to sense distance. The bearing is measured using precision encoders on the beam steering mechanics. These typically track a single corner cube retroreflector.

Laser beam steering is used in both photogrammetry and laser tracker technologies. The inventors have found that it is impossible for any state-of-the-art steering device used for laser beam steering to maintain a constant angular speed or scanning frequency in varying ambient conditions. The inventors have discovered that variations in ambient conditions, such as, for example, changes in temperature, can negatively affect the amplitude or linearity of the scan pattern of laser beam steering devices.

### SUMMARY

The present disclosure provides a technological solution that addresses and resolves the effects of ambient conditions on the amplitude or linearity of scan patterns of laser beam steering devices, including in laser beam steering applications for an O-LAMM system. The technological solution includes the system, method, or device provided by this disclosure.

According to an aspect of the disclosure, an apparatus is provided for orthogonal laser metrology having one or more orthogonal laser metrology modules (O-LAMMs). The apparatus comprises: a first monolithic structure that includes a first plurality of components preinstalled and aligned in the first monolithic structure, at least one of the first plurality of components comprising a bidirectional beam steering device; and a second monolithic structure that includes a second plurality of components preinstalled and aligned in the second monolithic structure, wherein: the first monolithic structure has a first connecting portion; the second monolithic structure has a second connecting portion; the first monolithic structure and the second monolithic structure are each constructed to be aligned and adjoined to each other at an interface of the first connecting portion and the second connecting portion; and the first plurality of components are preinstalled and optically aligned in the first monolithic structure such that when the first monolithic structure and the second monolithic structures are adjoined to each other at said interface, the second plurality of components are aligned with the first plurality of components.

The at least one of the first connecting portion and the second connecting portion can include a bevel portion and/or a planar surface formed at an angle with the bevel portion.

The first monolithic structure can comprise a first support member and a second support member.

Each of the first plurality of components are preinstalled and connected to both the first support member and the second support member. The first plurality of components comprise at least one of a mirror, a lens, a prism, a feedback sensor device, a position sensor device, and a beam steering device.

The apparatus can further comprise an adjustable support that includes at least one side having a surface that is constructed to match and engage the bevel portion for three-point support.

The first support member includes a first plurality of pin holes; the second support member includes a second plurality of pin holes; each of the first plurality of components has a first pin and a second pin; and each of the first plurality of components is connected to the first support member at its first pin and connected to the second support member at its second pin. Each of the first plurality of pin holes can be aligned with a corresponding one of the second plurality of pin holes.

The first plurality of components and the second plurality of components comprise at least one of a mirror, a lens, a prism, a collimator, a feedback sensor device, a position sensor device, a beam steering device, and a coherent energy source.

At least one of the first plurality of components comprise a mirror configured to receive a retroreflected beam of coherent energy and redirect the retroreflected beam of coherent energy to a surface of the bidirectional beam steering device; and at least one of the second plurality of components is configured to receive the beam of coherent energy and direct it to another surface of the bidirectional beam steering device.

The first monolithic structure can comprise a pair of feedback sensors and position sensing sensor that are preinstalled and aligned with the first plurality of optical components. Each of the pair of feedback sensors can be configured to detect an end of a beam scan pattern and the position sensing sensor is configured to detect a centroid of laser dot.

According to a further aspect of the disclosure, a computer-implemented method is provided for orthogonal laser metrology using a monolithic structure having one or more orthogonal laser metrology modules (O-LAMMs). The method comprises: scanning a laser beam, by a beam steering device, along a first direction in a spatial plane; receiving, from a feedback sensor, a feedback signal indicating an end of scan along the first direction in the spatial plane; scanning the laser beam, by the beam steering device, along a second direction in the spatial plane; receiving, from a position sensor device (PSD), a beam position signal indicating a beam spot centroid of the laser beam along a line in the spatial plane; calculating, by a processor, the beam spot centroid location based on at least one of the beam position signal and the feedback signal; and calculating, by the processor, a correction based on the beam position signal and the feedback signal; and applying, by the processor, the correction to the beam position signal to provide a real-time location of the beam spot centroid.

The method can further comprise receiving, from a second feedback sensor, a second feedback signal indicating a second end of scan along the second direction in the spatial plane, wherein calculating the correction is based on the beam position signal and the feedback signal and the second feedback signal.

The correction can comprise a change in gain or offset in the position sensor device (PSD).

The method can further comprise calculating, by the processor, a scan angle of the beam steering device based on at least one of the beam position signal, the feedback signal, and the second feedback signal.

The beam steering device can comprise a bidirectional beam steering mirror.

The at least one of the first feedback sensor and the second feedback sensor can comprise a photodiode. The photodiode can be optically aligned with a rhomboid prism.

The position sensor device (PSD) can comprise a line sensor. The position sensor device (PSD) can be optically aligned with a split aperture configured to block light other than light indicating the beam spot centroid of the laser beam along the line in the spatial plane.

Additional features, advantages, and embodiments of the disclosure may be set forth or apparent from consideration of the detailed description and drawings. Moreover, it is to be understood that the foregoing summary of the disclosure and the following detailed description and drawings provide non-limiting examples that are intended to provide further explanation without limiting the scope of the disclosure as claimed.

### BRIEF DESCRIPTION OF THE DRAWINGS

The accompanying drawings, which are included to provide a further understanding of the disclosure, are incorporated in and constitute a part of this specification, illustrate embodiments of the disclosure and together with the detailed description serve to explain the principles of the disclosure. No attempt is made to show structural details of the disclosure in more detail than may be necessary for a fundamental understanding of the disclosure and the various ways in which it may be practiced.

FIG. 1 shows a schematic diagram of a one-dimensional (1D) scanning Laser Metrology Module (LAMM).

FIG. 2 shows a schematic diagram of a two-dimensional (2D) LAMM.

FIG. 3 shows a nonlimiting implementation of an O-LAMM system.

FIGS. 4(A)-4(E) (collectively referred to as “FIG. 4”) show various views of a nonlimiting embodiment of an O-LAMM (or MO-LAMM) system comprising first and second monolithic parts.

FIG. 5 shows a partially exploded view of the O-LAMM system of FIG. 4.

FIG. 6 shows a side view of the O-LAMM system of FIG. 4

FIG. 7 shows a partial, cross-cut view of the O-LAMM system of FIG. 6 cut along a line A-A.

FIG. 8 shows an exploded, three-dimensional perspective view of the O-LAMM system of FIG. 4.

FIG. 9 shows a partial view of a portion of the O-LAMM system of FIG. 4, with the controller and other components removed to illustrate an outer side of a feedback sensor mounting plate.

FIG. 10 shows a view of the O-LAMM system of FIG. 4 with components removed to show an inner side of the feedback sensor mounting plate in FIG. 9.

FIGS. 11A-11D show various views of a nonlimiting embodiment of a position sensor mounting base included in the O-LAMM system of FIG. 4, including an inner view (FIG. 11A), an outer view (FIG. 11B), a side view (FIG. 11C), and a perspective inner view (FIG. 11D).

FIG. 12 shows an example of later beam displacement in the O-LAMM system of FIG. 4.

FIG. 13 shows a nonlimiting example of a sequential signal acquired by a controller in the O-LAMM system of FIG. 4.

FIG. 14 shows a process that can be performed by the O-LAMM system.

The present disclosure is further described in the detailed description that follows.

### DETAILED DESCRIPTION

The disclosure and its various features and advantageous details are explained more fully with reference to the non-limiting embodiments and examples that are described or illustrated in the accompanying drawings and detailed in the following description. It should be noted that features illustrated in the drawings are not necessarily drawn to scale, and features of one embodiment can be employed with other embodiments as those skilled in the art would recognize, even if not explicitly stated. Descriptions of well-known components and processing techniques may be omitted so as to not unnecessarily obscure the embodiments of the disclosure. The examples are intended merely to facilitate an understanding of ways in which the disclosure can be practiced and to further enable those skilled in the art to practice the embodiments of the disclosure. Accordingly, the examples and embodiments should not be construed as limiting the scope of the disclosure. Moreover, it is noted that like reference numerals represent similar parts throughout the several views of the drawings.

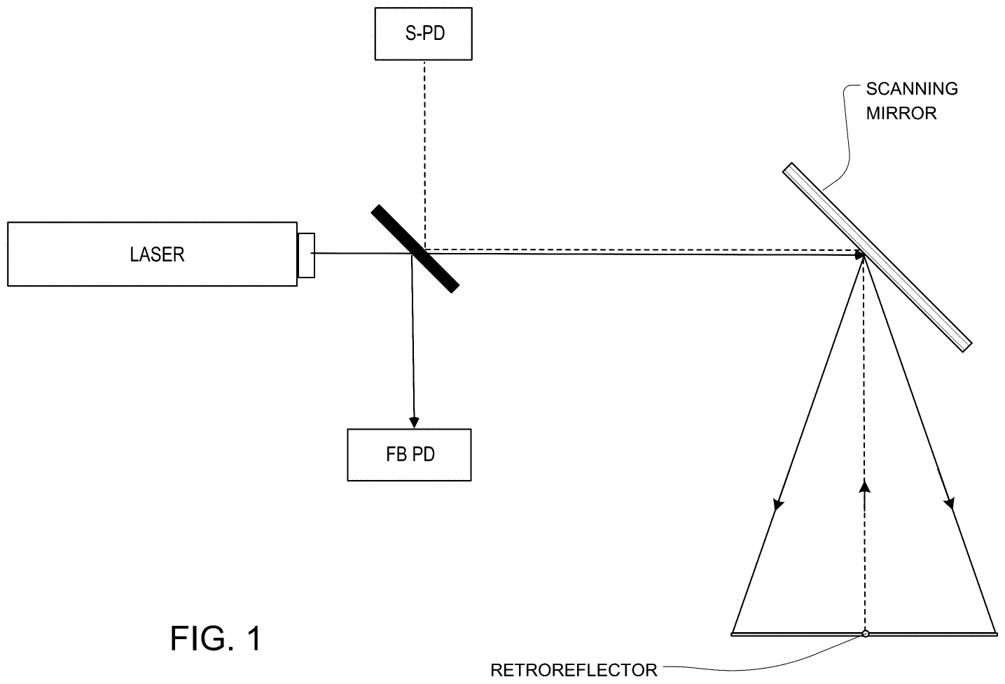

FIG. 1 shows a schematic diagram of a one-dimensional (1D) scanning laser metrology module (LAMM). In the 1D LAMM, a laser generates and directs a collimated laser beam that serves as a light source. A beam-splitter directs a small portion of the light beam to a feedback (FP) photodiode (PD), while a majority of the light beam is channeled to a scanning mirror driven by a beam steering device (not shown). Within a scanning field of the 1D LAMM, a single retroreflector is provided at a center of the scanning line. A dashed line illustrates a retroreflected light beam's trajectory, which aligns precisely with a path of the original incident light beam. Beneath the scanning line, a time axis depicts the sequential signals received by the FB PD and a sensing photodiode (S-PD).

The 1D LAMM can correlate the time at which the laser beam impinges on the retroreflector to a mirror angle at a time of reflection. Considering the significantly high speed of light and the distance between the FB PD and S-PD in the order of, for example, meters, it is reasonable to assume that the laser beam impinges on both the FB PD and S-PD concurrently. Given the known angular speed of the steering mirror as ω, an angle of θ, representing the mirror angle at the time of reflection, can be computed as follows: θ=ω·Δt, where Δt denotes a time interval between the instance to at the start of a scan and the time when the S-PD receives the retroreflected beams. In the example depicted in FIG. 1, Δt can be defined as 0.5·(t₁+t₁′)−t₀, with the assumption that the light beam pulse is simplified as a square waveform. In reality the time-resolved retroreflected beam obtained by the S-PD typically exhibits a Gaussian distribution. Under such circumstances, Δt may be determined using an alternative algorithm rather than taking the average. Nonetheless, the underlying mechanism serves as the fundamental physics for converting the temporal information recorded by the system into spatial distribution.

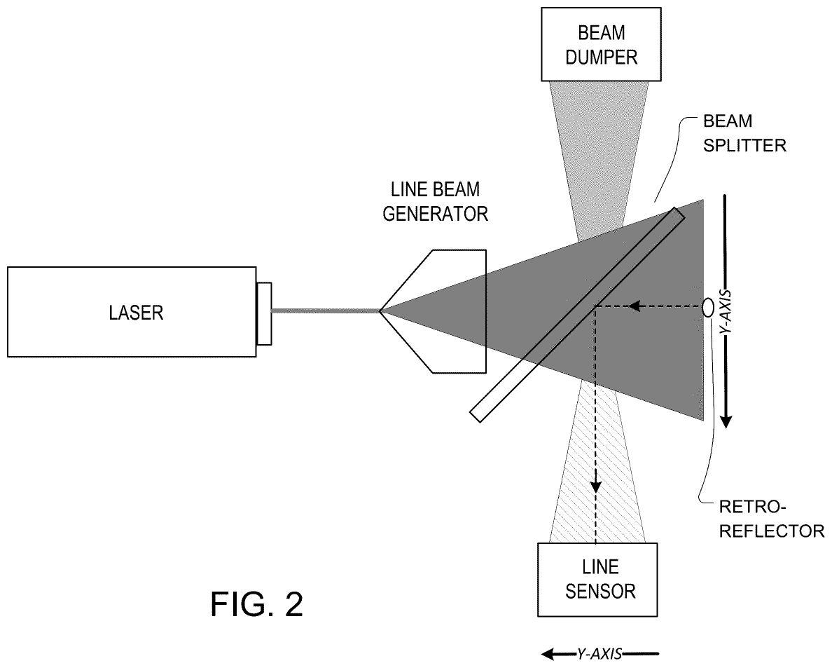

FIG. 2 shows a schematic of a two-dimensional (2D) LAMM—i.e., an orthogonal laser metrology module (O-LAMM). In FIG. 2, the schematic diagram is simplified to exclude the 1D LAMM (shown in FIG. 1), which is used to achieve x-axis positioning using temporal measurements, as discussed above.

Referring to FIG. 2, the O-LAMM builds on the 1D LAMM technology and provides two-dimensional (2D) laser metrology. An important aspect of the O-LAMM system is its implementation of a laser line scan as opposed to a single laser dot scan to scan for positioning retroreflectors. This characteristic enables the O-LAMM to accurately locate targets within a 2D conical region using 1D scanning techniques. The laser line scan covers a larger area in a single sweep, allowing for more efficient data acquisition and improved target location accuracy compared to single laser dot scan methodologies. The O-LAMM system is able to operate within as a closed-loop positioning system, thereby improving overall accuracy and performance of the host system.

In the O-LAMM system, a line beam generator is provided to convert the 1D coherent light beam from the laser to a 2D light beam. This optical component can include a cylindrical lens or a Powell lens. The Powell lens can exhibit significant improvement in line generator performance compared to the cylindrical lens. For instance, the illuminated line produced by a cylindrical lens is non-uniform and Gaussian in nature.

In the O-LAMM system, the line beam produced by the Powell lens is divided into two paths by a beam splitter. When the primary optical path of the line beam, perpendicular to the scanning axis, encounters a retroreflector, the reflected light is directed back to a line sensor (for example, CCD line sensor), while the unused path is terminated by a beam dumper. The reflected light striking different positions on the line sensor corresponds to distinct angles within the scanned laser line. This spatial relationship enables the determination of y-axis positioning in the 2D metrology system.

A plurality of O-LAMM systems can be set at known positions within a measurement environment, such that a triangulation process for determining the z-axis of the target retroreflectors becomes more robust and reliable. Having precise coordinates of the O-LAMM units allows for a more accurate calculation of the geometric relationships and intersection points between the line-of-sight vectors originating from each O-LAMM. This setup not only enhances the accuracy of a 3D metrology system, but also ensures greater repeatability and consistency in determining the three-dimensional coordinates of the target retroreflectors in the measurement space.

In an embodiment, an O-LAMM system is provided that combines 1D scanning with a single-axis steering mirror, a line beam generator, and a high-resolution, high-speed line sensor to scan a volume. The system can provide real-time feedback in various applications, including, for example, correcting the motion of robots or mechanical systems. The system can include timestamping to ensure accurate and precise timing of each reflector position detection.

In various embodiments, two or more O-LAMM systems are integrated using PLX's MOST® technology, which maintain arcsecond accuracy. In at least one embodiment of the multi-O-LAMM (or MO-LAMM) system, a second O-LAMM unit can be positioned at a predetermined distance from a first O-LAMM unit to facilitate the capture of z-axis information through triangulation. The Cartesian coordinates (i.e., x-, y-, z-coordinates) of each O-LAMM unit can be used in the triangulation process. MO-LAMM systems with constellations of multiple reflectors can be seamlessly networked to reduce or eliminate blind spots within a target volume, allowing for accurate determination of target position(s) and pose six-degrees-of-freedom (6DoF).

In certain embodiments, the O-LAMM system can include single-axis scanning of a line beam to achieve 2D angular measurements. The O-LAMM system is capable of determining an angle at a scanning direction (e.g., along an x-axis) by converting detected temporal signals and an angle at a beam spanning direction (e.g., along a y-axis) by analyzing the geometry of optics from the reflected beam falling on different positions of a line sensor corresponding to different angles within the scanned laser line. The O-LAMM system, which is applicable to 2D geometries, is extendible to three-dimensional (3D) applications by integrating multiple LAMM units to form a MO-LAMM for real-time metrology, enabling the determination of the range of a target and its lateral position. The advantages of MO-LAMM include a balance of cost and precision in comparison to current systems for industrial metrology applications. Additionally, the integration of MO-LAMM with monolithic optical structure technology (M.O.S.T®) can provide vital real-time information required in many applications and industries, including, for example, adaptive manufacturing.

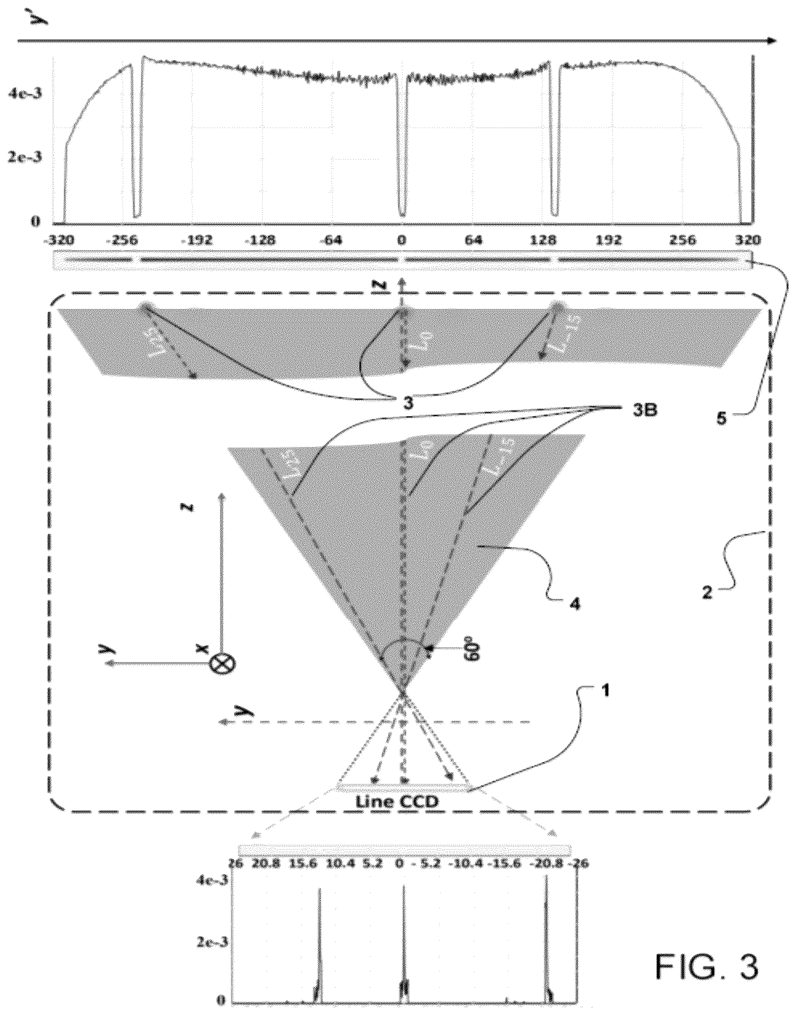

FIG. 3 shows a non-limiting implementation of an O-LAMM system, according to the principles of the disclosure. As seen in the illustration, the O-LAMM system can be configured to provide line beam geometry necessary for determining the positions of a plurality of target retroreflectors (e.g., 3 target retroreflectors) based on their reflected signals according to a line CCD (charge-coupled device) sensor 1. The shown results obtainable by the O-LAMM system and simplified optical geometry illustrate a mechanism of y-axis location. The simplified optical geometry illustrating the y-axis positioning mechanism for the O-LAMM system are presented within a central dashed-line rectangle 2 in FIG. 3. Three retroreflectors 3 are positioned at −15°, 0°, and 25° relative to the z-axis. The laser beam, spanning 60° through the Powell lens (not shown in the figure), is represented as a light fan-shaped area 4. When the line beam intersects with the three retroreflectors 3, the corresponding beam segments 3B are reflected along the same path but in the opposite direction. The dashed lines representing the reflected beams 3B, including light beams L₋₁₅, L₀, and L₂₅, which correspond to the beams 3B reflected by the retroreflectors at −15°, 0°, and 25°, respectively. The line CCD sensor 1 records the reflected signals 3B, while another rectangular detector 5 positioned behind the retroreflectors is utilized to validate their positions.

The images capturable by the beam detectors 5 and 1 are depicted in FIG. 3 as upper and lower charts, respectively, corresponding to the actual imaging and positions, respectively. The y-axis locations can be visualized and quantified by examining the spatial intensity profiles of the images, obtained by selecting the central line L₀ of the strongest beam 3B. As seen, the y-axis positions of the retroreflectors 3 in the imaging coordinate (peak positions in the lowermost graph) are linearly proportional to the corresponding positions in the actual coordinate (valley positions in the uppermost graph) relative to the intercept of the starting point of the spanning beam-fan 4. The retroreflector positions in the imaging plane are indicated by the peaks, as the laser beam intensities are reflected by the retroreflectors 3. As noted above, when multiple O-LAMM units are set at predetermined positions within the measurement environment, the triangulation process for determining the z-axis, as well as x- and y-axis, of the target retroreflectors 3 becomes more robust and reliable. Having precise coordinates of the O-LAMM units allows for a more accurate calculation of the geometric relationships and intersection points between the line-of-sight vectors originating from each O-LAMM unit.

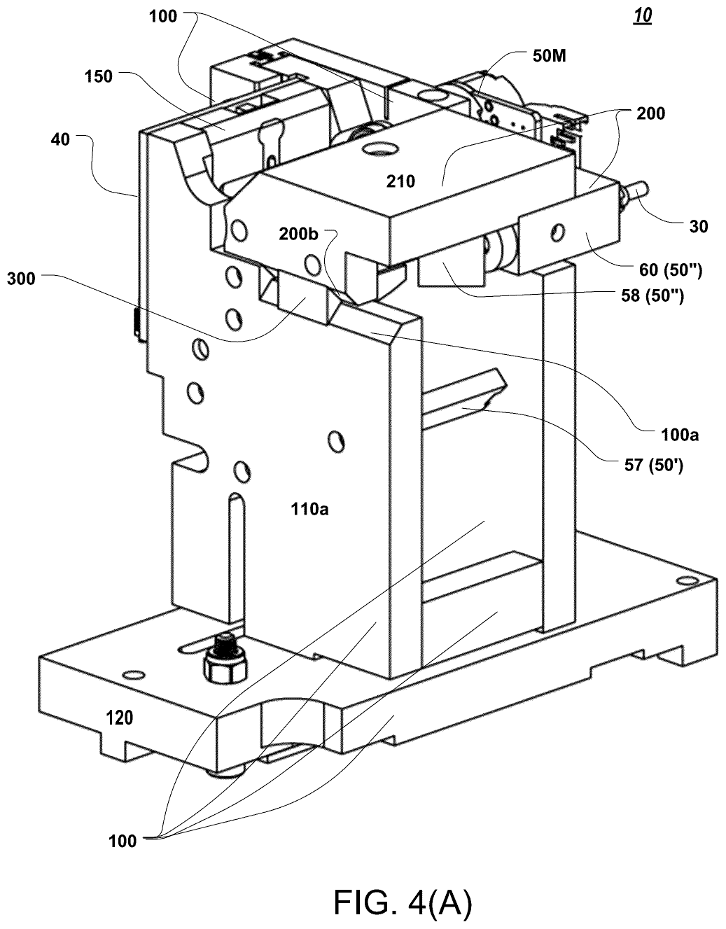

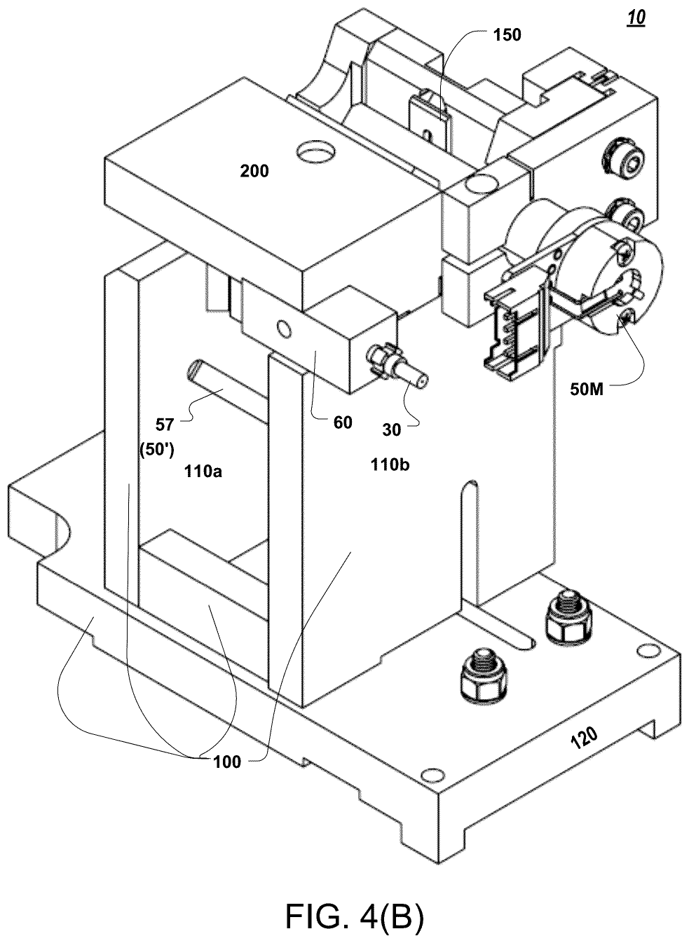

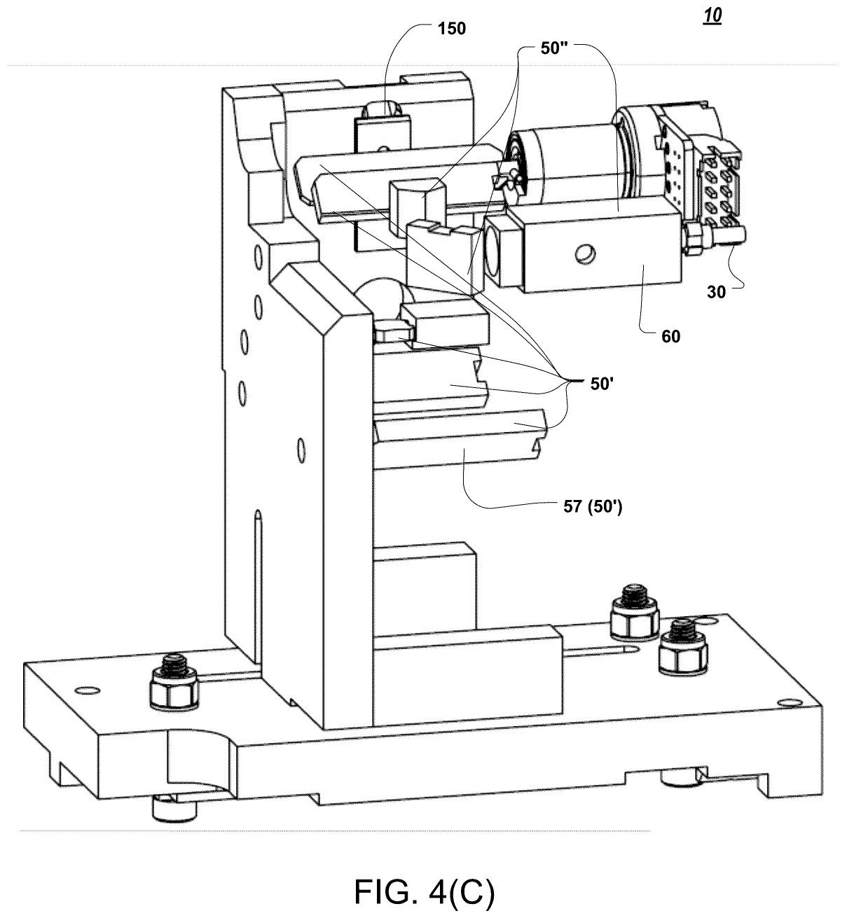

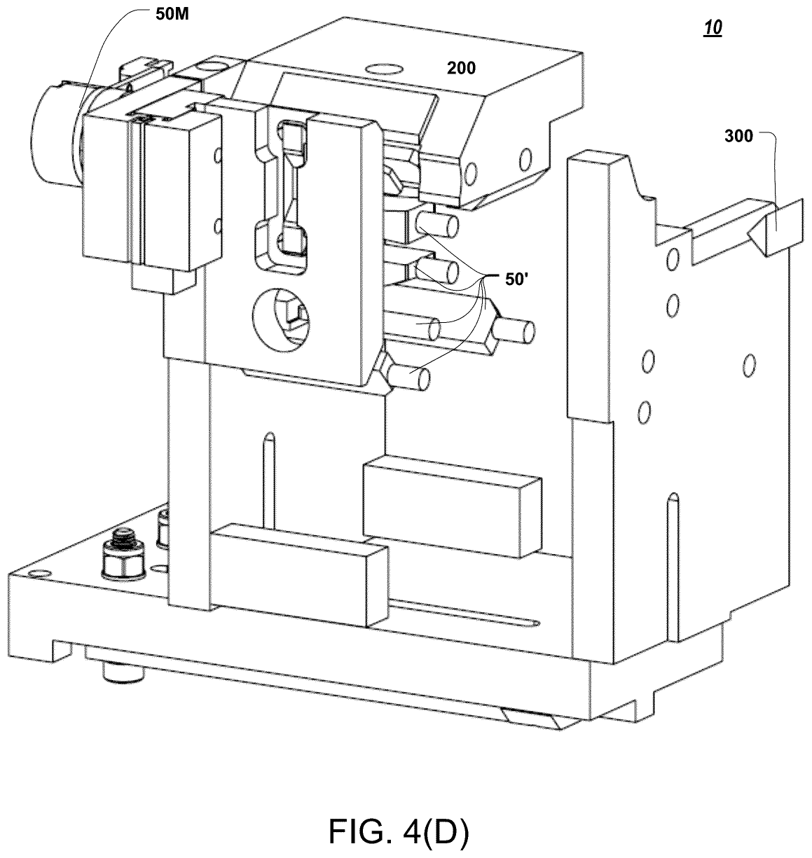

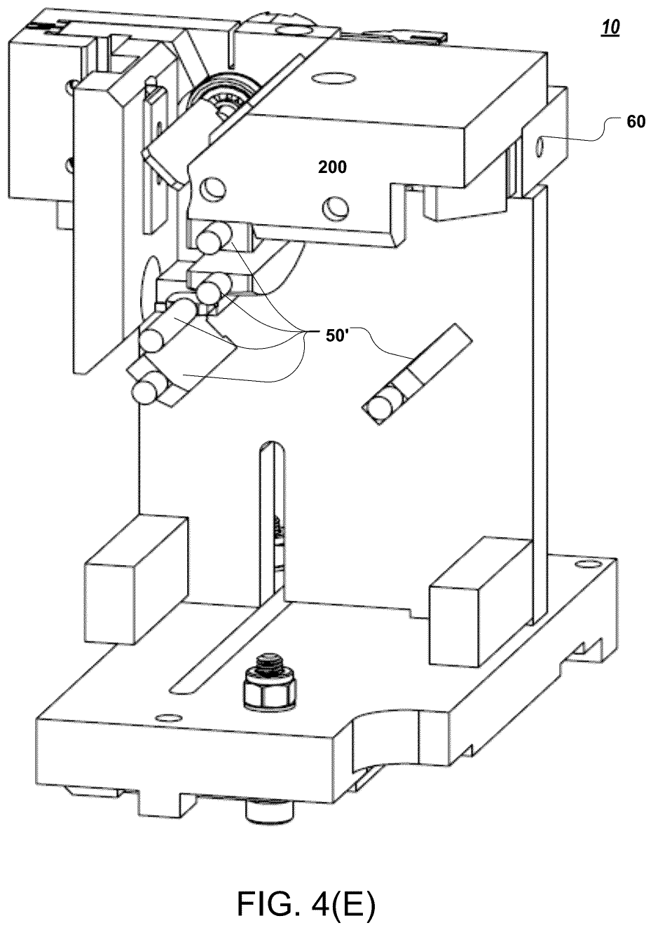

FIGS. 4(A)-4(E) (collectively referred to as “FIG. 4”) show various views of a nonlimiting embodiment of an O-LAMM (or MO-LAMM) system 10, constructed according to the principles of the disclosure. The O-LAMM system 10 includes a modular solution that integrates a first monolithic part 100 and a second monolithic part 200, each of which can include PLX's Monolithic Optical Structure Technology® (or MOST®). The O-LAMM system 10 includes a coherent energy source 30 that can be preinstalled and optically pre-aligned in the second monolithic part 200, and a controller 40 which can be pre-installed in either the first monolithic part 100 or the second monolithic part 200. The O-LAMM system includes a beam steering system 50, which includes a first set of optical components 50′ preinstalled and optically aligned in the first monolithic part 100 and a second set of optical components 50″ preinstalled and optically aligned in the second monolithic part 200, wherein the first and second sets of optical components 50′, 50″ are preinstalled such that when the first and second parts 100, 200 are assembled, the optical components 50′, 50″ are optically aligned to form the optical system 50. The first monolithic part 100 can include a pair of support members 110a, 110b, at least one of which can include a contact region having a bevel portion 100a for three-point contact. The first monolithic part 100 includes a preinstalled and optically aligned sensor mounting base 150. The second monolithic part 200 has a body 210 that can include at least one contact region having a bevel portion 200b for three-point contact.

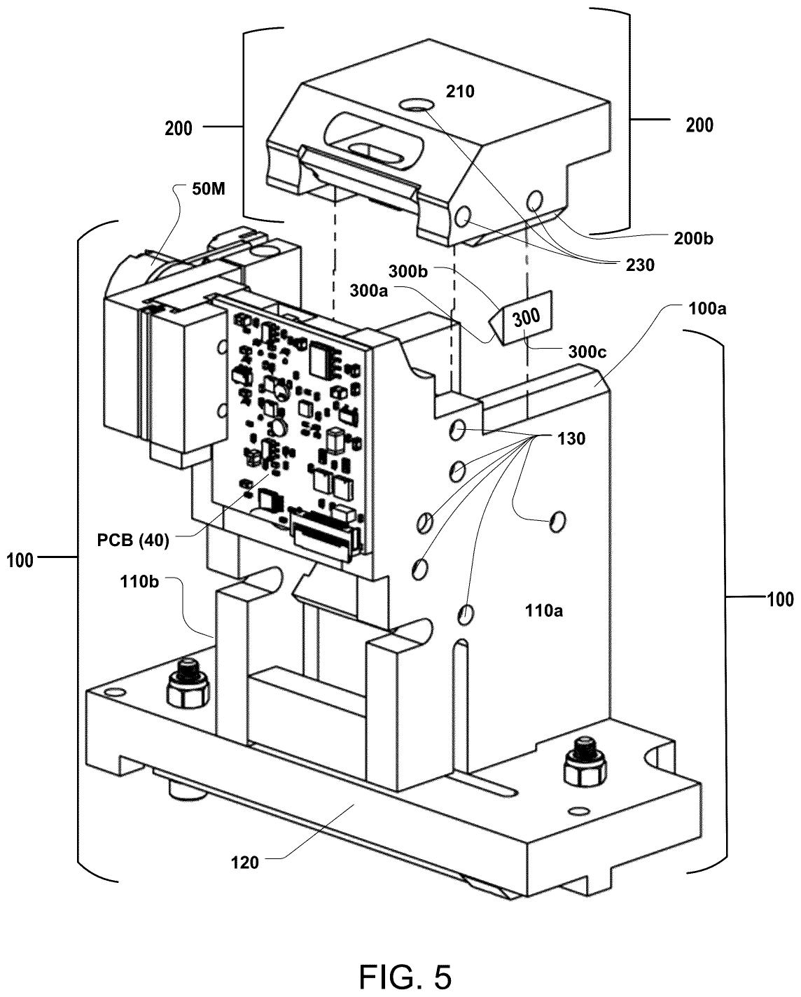

The O-LAMM system 10 includes all optical, mechanical and electrical components, including the laser source 30, controller 40, and precision beam steering system 50 (including optical components 50′ and 50″), required to create a compact and robust three-dimension (3D) laser scanning system 10 that can be implemented for in situ metrology. The beam steering system 50 is discussed in greater detail below, with respect to FIGS. 5-10. All of the components (including optical components 50′, 50″) in the first monolithic part 100 and the second monolithic part 200 are preinstalled and optically aligned, before the O-LAMM system 10 is assembled. The modular structure of the O-LAMM system 10 facilitates easy assembly or replacement of monolithic parts.

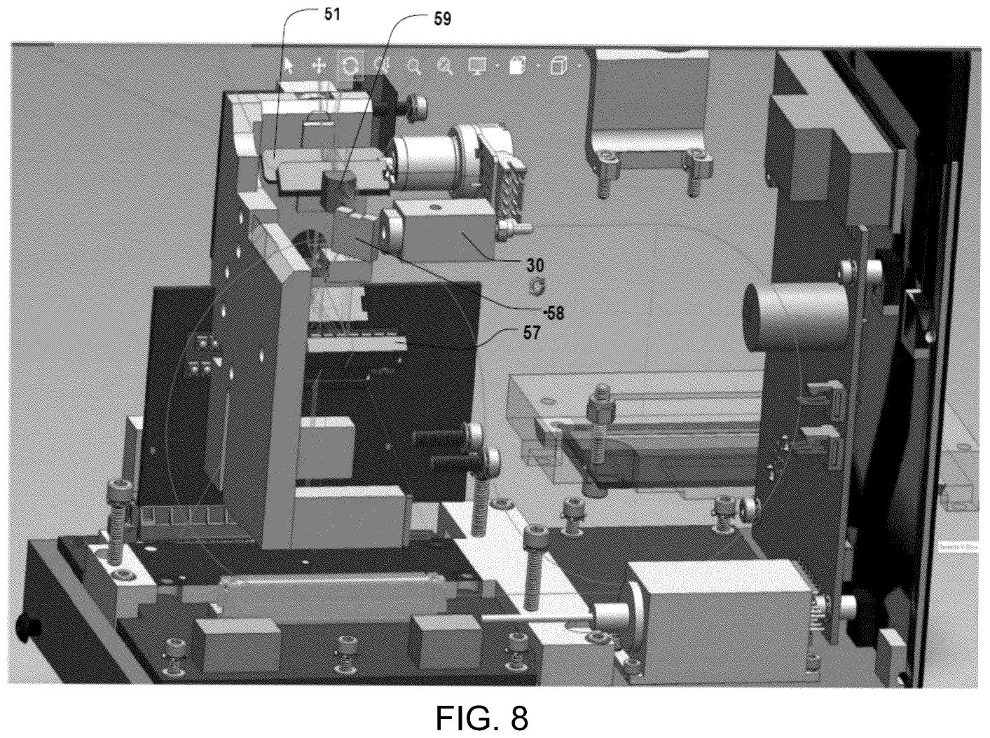

The laser source 30 can be preinstalled and optically aligned with the optical components 50″ (including, for example, optical components 58, 59, and 60, shown in, e.g., FIGS. 5 and 8) in the second monolithic part 200, before the first and second monolithic parts 100, 200 are aligned and fixedly coupled. The laser source 30 is configured to generate and emit a coherent beam of light (laser beam) and direct the light beam into a first optical component (for example, collimator 60), which in turn directs the light to a second optical component (for example, mirror 58). The optical component 58 redirects the light beam to a bidirectional steering device 51, either directly or through a third optical component (for example, beam splitter 59).

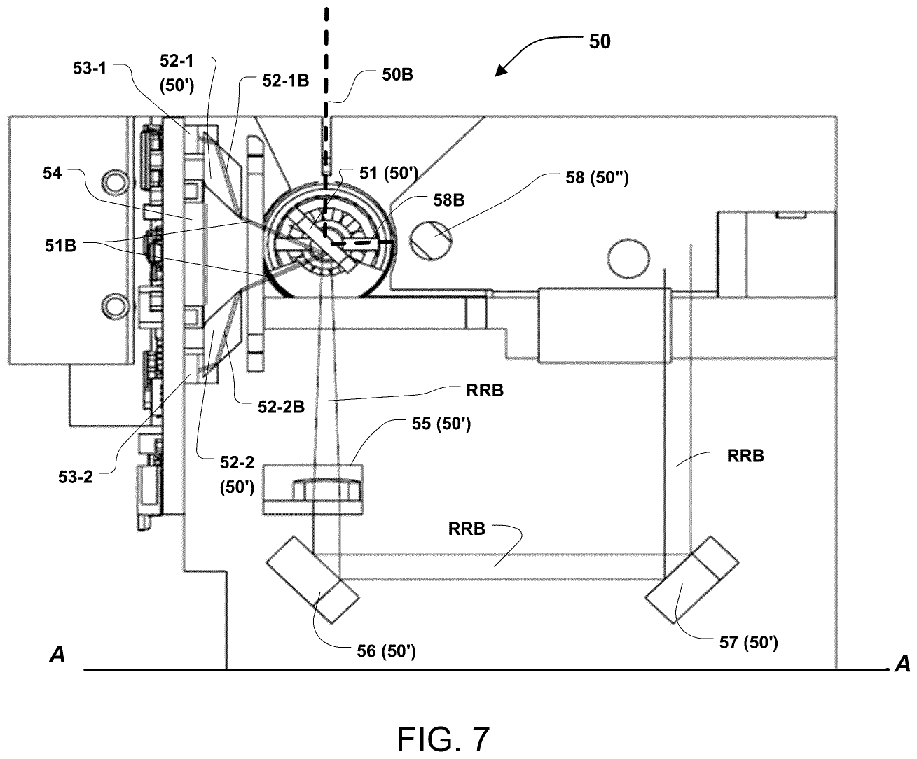

The controller 40 can be preassembled in either the first monolithic part 100 or the second monolithic part 200. In various embodiments, the controller 40 is installed in a housing that is affixed to, or installed on/in, at least one of the support members 110a, 110b. In various embodiments, the controller 40 includes a PCB (printed circuit board) control unit (shown in FIG. 5). The PCB control unit can include feedback sensors 53-1, 53-2, and a position sensor 54 (shown in FIG. 7). In at least one embodiment, the controller 40 (or PCB control unit) includes the detection, monitoring and control circuitry described with reference to, inter alia, FIG. 5 in United States Patent Application Publication No. US 2022/0326379, published Oct. 13, 2022, titled “System and Method for Orthogonal Laser Metrology,” which is hereby incorporated herein in its entirety.

In the embodiment depicted in FIG. 5, the controller 40 is preinstalled in a housing that is affixed to the support members 110a and 110b. The controller 40 can be installed in the first monolithic part 100 before the first and second monolithic parts 100, 200 are aligned and fixedly coupled.

The beam steering system 50, and more particularly the first set of optical components 50′, includes the bidirectional beam steering device 51 (shown in FIGS. 5-8). The device 51 can include, for example, a galvo mirror, a MEMS (micro-electromechanical system) device, or a resonant mirror, that is configured to receive a first light beam on a first surface of the device 51 along a first longitudinal axis and redirect and steer the first beam along a second axis (such as, for example, in a fan pattern) as a light beam 50B that is emitted from the O-LAMM system 10. The bidirectional beam steering device 51 can be coupled to a motor 50M. The bidirectional beam steering device 51 is further configured to receive a second light beam on a second surface (for example, a surface opposite the first surface) and redirect and steer the second beam to a pair of feedback sensors 53-1, 53-2, and a position sensor device 54. The feedback sensors 53-1, 53-2 can include, for example, a photodiode, a CCD sensor, or other device capable of detecting a laser beam spot and generating and sending a signal when a laser beam spot is detected. The position sensor (PSD) 54 can include, for example, an array of photodiodes, a CCD line sensor, or other line sensor capable of detecting a laser beam spot centroid and generating and sending a beam position signal indicating the real-time position of the laser beam spot centroid. The optical components 50′ of the beam steering system 50 can be installed in the first monolithic part 100 before the first and second monolithic parts 100, 200 are aligned and fixedly coupled.

The bevel portions 100a and 200b can be configured to contact (or mate with) a respective surface of an adjustable support 300, so as to provide a third point of contact for each of the first monolithic part 100 and the second monolithic part 200. In monolithic particular, the interfaces between the bevel portions 100a, 200b and their corresponding respective surfaces 300a, 300b (shown in FIG. 5) on the adjustable support 300 provide a third point of contact, via the adjustable support 300, between the first monolithic part 100 and the second monolithic part 200. The adjustable support 300, including the contact surfaces 300a and 300b, is configured to facilitate aligning the first monolithic part 100 and the second monolithic part 200 during assembly such that the optical components 50′, 50″ in each of the first and second monolithic parts 100, 200, respectively, are properly aligned.

The adjustable support 300 can be configured to address manufacturing tolerances, including imperfections in machining in the connecting portions of the first and second monolithic parts 100, 200. The adjustable support 300 can include a wedge having five sides (as seen in FIG. 4), including the three sides 300a, 300b, and 300c (shown in FIG. 5) formed at angles with respect to each other such that the sum of angles is 180°. The sides 300a and 300b can be formed at an angle of between 30° and 150° (such as, for example, an angle of) 90° with respect to each other, each side 300a, 300b having a planar face configured to contact and support the bevel portions 100a, 200b, respectively.

The adjustable support 300 can be installed after the first monolithic part 100 and the second monolithic part 200 connected and all components (including the internal optical components 50′, 50″) aligned. In particular, after the first and second monolithic parts 100, 200 are aligned and connected, the adjustable support 300 is installed and its position manipulated until the optical components 50′ in the first monolithic part 100 are aligned with the optical components 50″ in the second monolithic part 200. Once the beam steering system 50 in part 100 is optically aligned, with the optical components 50′ in part 100 optically aligned with the optical components 50″ in the part 200, the first monolithic part 100 and second monolithic part 200 can be securely affixed to each other by, for example, a bond, a weld, an adhesive, or a housing structure the fixedly holds the monolithic parts 100, 200 together. In an embodiment, the support 300 can be secured to the first monolithic part 100 and/or second monolithic part 200 by the bond, weld, adhesive, or housing structure.

FIG. 5 shows a partially exploded view of the O-LAMM system 10. As seen, the support member 100a includes a plurality of pin holes 130, each configured to receive and securely hold an end portion, such as, for example, a mounting pin, of a component (including, for example, each of the optical components 50′) installed in the first monolithic part 100. The support member 100b can include a plurality of pin holes (not shown) corresponding to the plurality of pin holes 130 on the support member 100a, with each pin hole on the support member 100b positioned and aligned with a corresponding pin hole 130 and configured to receive and securely hold another end portion, such as, for example, another mounting pin, of the component, which can include, for example, a mirror, a lens, a lens assembly, a collimator, a beam splitter, a mirror, a light sensor, a photodiode, a photodiode array, a line sensor (for example, CCD line sensor), or other optical, mechanical, or electrical component to be preinstalled and pre-aligned in the monolithic part 100, such that the component is a part of monolithic structure of the first monolithic part 100.

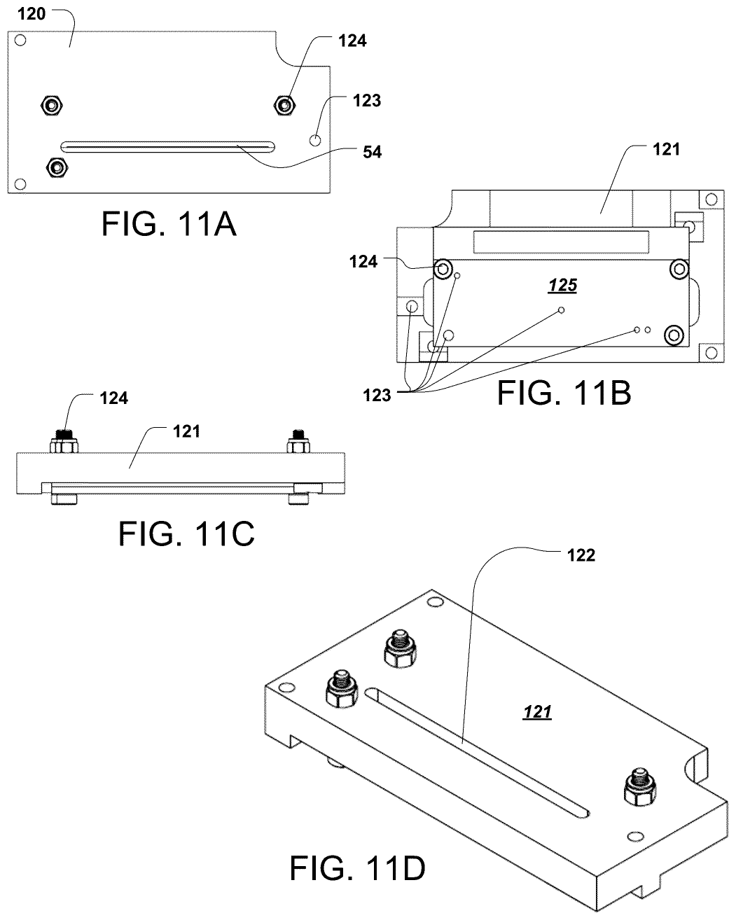

The monolithic structure of the first monolithic part 100 includes a mounting base 120 (shown in FIG. 5 and FIGS. 11A-11D) and the sensor mounting base 150 (shown in FIGS. 4, 9, and 10).

The second monolithic part 200 can include a plurality of pin holes 230 in the body 210. Each pin hole 230 is configured to receive and securely hold a portion, such as, for example, a mounting pin, of a component, including, for example, each of the optical components 50″, which include the mirror 58, the beam splitter 59, and the collimator 60 (shown in FIGS. 5 and 8). In the monolithic part 200, the component can include, for example, a collimator, a mirror, a lens, a beam splitter, a mirror, a light sensor, a photodiode, a photodiode array, a line sensor (for example, CCD line sensor), or other optical, mechanical, or electrical component to be preinstalled and pre-aligned in the monolithic part 200, such that the component is a monolithic component of the second monolithic part 200.

Each component in the first monolithic part 100 and the second monolithic part 200 can be preinstalled and optically aligned in the structure 100/200 such that it can be removed and replaced at a later time without any effect to any of the other components in that monolithic part, including, for example, without affecting the optical alignment of any component in either of the first monolithic part 100 or second monolithic part 200.

The monolithic optical structure of each of the first monolithic part 100, the second monolithic part 200, and the adjustable support 300 is configured and constructed to be invariant to extreme changes in ambient conditions in an application environment, such as, for example, temperature changes of ±120° C., pressure ±110 MPa (about 16,000 psi), or humidity of ±30 g/m³. The first part 100, the second part 200, and the third part 300 can be made of the same or a different material. In various embodiments, the first part 100, the second part 200, and/or third part 300 are made of a material comprising, for example, glass, composite glass, chemically strengthened glass, borosilicate glass, germanium-oxide glass, heat resistant glass, N-BK7 glass, annealed glass, heat strengthened glass, toughened glass, or laminated glass.

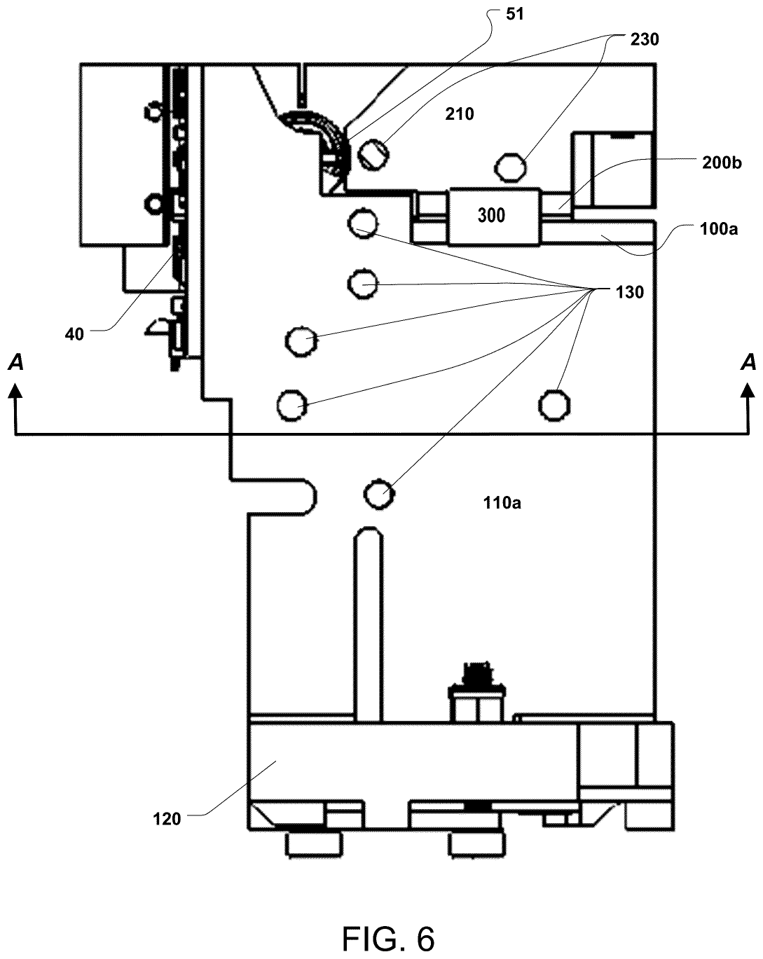

FIG. 6 shows a side view of the O-LAMM system 100, and FIG. 7 shows a monolithic partial, cross-cut view of the O-LAMM system 100 cut along the line A-A in FIG. 6, with the support member 110a removed to show the components 51-57, each of which is preinstalled and pre-aligned in the structure of the first monolithic part 100 be invariant to ambient conditions.

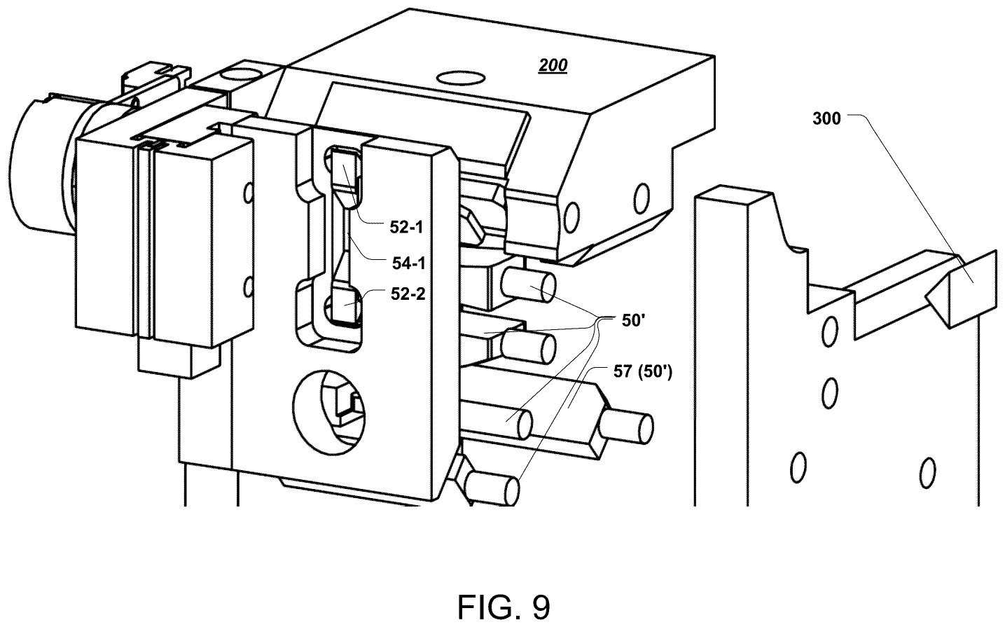

Referring to FIG. 7, an embodiment of the beam steering system 50, which includes the optical components 50′ preinstalled and pre-aligned in the first monolithic part 100, includes a steering mirror 51, a pair of beam de-position optical components 52-1, 52-2, a pair of corresponding discrete sensors 53-1, 53-2, a position sensing detector (PSD) 54, a lens 55, a mirror 56, and a mirror 57. The optical components 52-1, 52-2 and sensors 53-1, 53-2 can be preinstalled on the sensor mounting base 150 (shown in FIGS. 7 and 9) and optically aligned with the other optical components in the beam steering system 50. The PSD 54 can be preinstalled on the mounting base 150 and aligned with the beam steering system 50. Each of the optical components 50′ is preinstalled, optically aligned, and invariantly affixed in the monolithic part 100, except that the beam steering device 51 is installed to frictionlessly and freely steer laser beams in a fan pattern; and each of the optical components 50″ (including components 58-60) is preinstalled, optically aligned, and invariantly affixed in the second monolithic part 200.

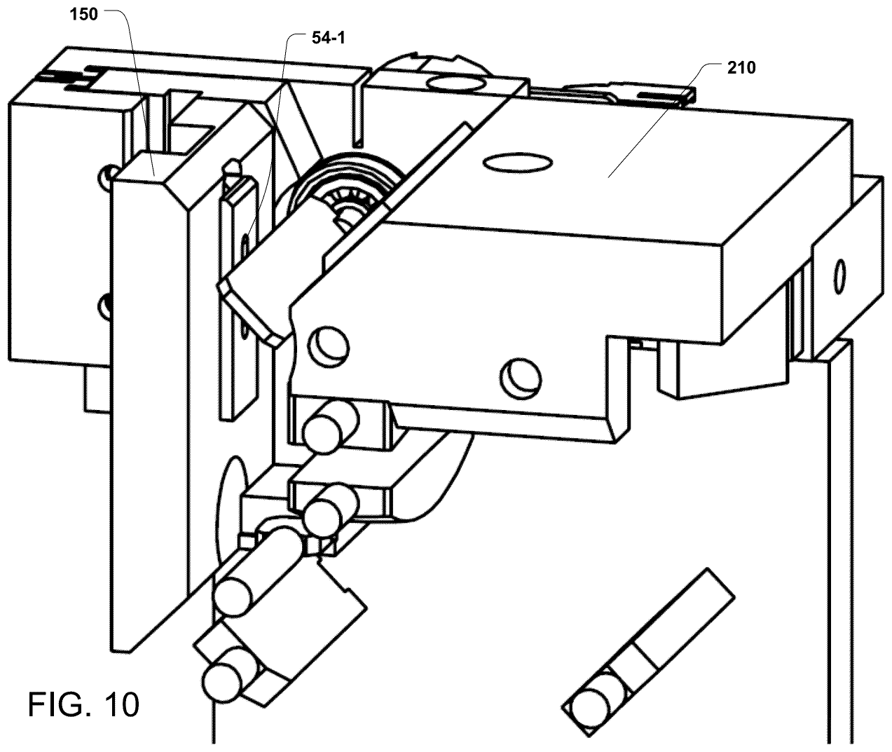

The optical components 50′ of the beam steering system 50 are preinstalled and aligned in the first monolithic part 100 such that, when the first and second monolithic parts 100 and 200 are aligned and coupled to each other, the beam steering device 51 receives a first coherent light beam on a first surface of the device from the collimator 60, either as a reflected beam from the mirror 58 or a beam from the beam splitter 59 after it is reflected by the mirror 58 (shown in FIG. 8). The device 51 receives the first beam along a first direction and emits the beam 50B from the O-LAMM system 10. The beam steering device 51 is also aligned such that, when a retroreflected beam (RRB) is received by the O-LAMM system 10, the retroreflected beam RRB is redirected via the optical components in the O-LAMM system 10 to a second surface of the device 51 (for example, on the opposite side of the device, opposite the first surface), which then steers and directs the RRB beam to the feedback sensors 53-1, 53-2, and PSD 54. The optical components 50′ include, for example, the lens assembly 55 and the mirrors 56-57. The RRB beam is redirected by the beam steering device 51 to the position detectors 53-1, 53-2 via the optical components 52-1, 52-2, respectively. The RRB beam is also directed to the PSD 54 via a slit aperture 54-1 in the sensor mounting base 150 (shown in FIGS. 9 and 10).

In various embodiments of the O-LAMM system 10, the PSD 54 and feedback sensors 53-1, 53-2 can be preinstalled in the same plane (for example, x-y, x-z, or y-z plane), or in different planes for maximal compactness of the O-LAMM system 10, as will be understood by those skilled in the art. As noted above, the PSD 54 and feedback sensors 53-1, 53-2 can be integrated into the PCB control unit.

The lens assembly 55 can be configured to direct and focus the RRB beam on to a surface of the beam steering device 51. The lens assembly 55 can include one or more lenses positioned along a longitudinal direction and configured to shape and direct the RRB beam to the surface of the beam steering device 51.

The beam steering device 51 can include, for example, a galvo mirror, a polygon scanner, a resonant mirror, a MEMS mirror, or other high-precision, high-speed mirror device. The beam steering device 51 can include multidirectional reflective surfaces, including bidirectional reflective surfaces. In at least one embodiment, the beam steering devices 51 includes a bidirectional galvo mirror 50M. The beam steering device 51 is configured to receive a first beam on a first reflective surface from the laser source via optical components 50″ (for example, 58, 59, 60) that are structurally integrated into the monolithic part 200, and a retroreflected beam (RRB) on a second reflective surface via optical components 50′ (for example, 52 and 55-57) that are structurally integrated into the monolithic part 100. The beam steering device 51 can, via the first reflective surface, steer and direct the first beam as a main scan line 50B, which can be in the form of a 2D beam scan pattern, such as, for example, the beam fan 4 (shown in FIG. 3). The beam steering device 51 can, via the second reflective surface, steer and direct the RRB beam to feedback sensors 53-1, 53-2, and/or PSD 54.

Referring to FIG. 7, the optical component 52-1 is configured to receive the beam 51B and redirect the beam, as beam 52-1B, to the feedback sensors (FB PD) 53-1, when the beam steering device 51 redirects the RRB beam to impinge on the optical component 52-1. Similarly, the optical component 52-2 is configured to receive the beam 51B and redirect the beam, as beam 52-2B, to the second feedback sensor (FB PD) 53-2, when the beam steering device 51 redirects the RRB beam to impinge on the optical component 52-2. Each of the optical components 52-2 and 52-2 can include, for example, a prism configured for beam de-position. The optical components 52-1, 52-2 are preinstalled on the mounting base 150 and aligned with beam steering system 50 in the monolithic part 100 prior to assembly with the part 200. In at least one embodiment, the feedback sensors 53-1, 53-2 and/or the PSD 54 also preinstalled on the mounting base 150 and aligned with the beam steering system 50.

Since it is impossible for any steering device, including, for example, galvo, MEMS, or resonant mirrors, to keep a constant angular speed and scanning frequency under changing ambient conditions over time, the O-LAMM system 10 is constructed such that variations in ambient conditions, such as, for example, significant changes in temperature, will not affect the amplitude or linearity of the scan pattern of the beam steering system 50, including the beam steering device 51, thereby maintaining the effective accuracy of the O-LAMM system 10. In this regard, the O-LAMM system 10 overcomes deficiencies inherent in laser beam steering systems when operating under varying ambient conditions by implementing spatial calibration obtained by the combination of the controller 40 and sensors 53-1, 53-2, 54, including temporal information measured by O-LAMM system 10 based on sensor signals received from the feedback sensors 53-1, 53-2 and the position sensing detector 54.

In the embodiment depicted in FIGS. 4-10, the sensors 53-1 and 53-2 each include a feedback (FB) photodiode (PD) and the position sensing detector (PSD) 54 includes a line CCD sensor. The sensors 53-1, 53-2, or 54 can include a light beam detection device, such as, for example, a phototransistor, a light-dependent resistor, a charge coupled device (CCD), or one or more arrays of any of the foregoing, or another device capable of detecting a laser beam in a manner similar to a FB PD.

The mounting base 150 is preinstalled and optically aligned with the beam steering system 50 in the structure of the first monolithic part 100. The mounting base 150 is preinstalled and affixed to both of the support members 110a, 110b. FIGS. 9 and 10 show views of the outer and inner sides, respectively, of the mounting base 150. As seen in FIG. 10, the mounting base 150 includes an aperture plate provided with the longitudinal slit aperture 54-1. The slit aperture 54-1 is aligned with the beam steering system 50 and configured to allow a line beam to pass through the longitudinal aperture to the sensors 53-1 and 53-2, and block all other light, thereby preventing any stray light from impinging on the sensors 53-1 or 53-2.

In at least one embodiment, the slit aperture 54-1 is aligned with the beam steering system 50 and configured to allow a line beam to pass through the longitudinal aperture to the sensors 53-1, 53-2, and the PSD 54, and block all other light, thereby preventing any stray light from impinging on the sensors 53-1 or 53-2 or 54.

The PSD 54 can include a linear array having a plurality of photodiodes, phototransistors, light-dependent resistors, or CCDs arranged in a 1D line and configured to detect a position at which a light beam dot impinges the PSD 54. The PSD 54 can be configured to detect and measure the intensity (or amplitude) of the light beam at the time of impingement. The PSD 54 can include one or more lenses atop of the photodetectors. The PSD 54 can be preinstalled on the sensor mounting base 150 and aligned with the beam steering system 50 in the first monolithic part 100.

FIGS. 11A-11D show various views of a nonlimiting embodiment of a mounting base 120 included in the O-LAMM system 10, including an inner view (FIG. 11A), an outer view (FIG. 11B), a side view (FIG. 11C), and a perspective inner view (FIG. 11D). As seen in the figures, the mounting base 120 includes a base body 121, an aperture 122, a plurality of pin holes 123, a fastener 124, and a cover plate 125. In an embodiment of the O-LAMM system, the aperture 122 can be configured receive and hold the PSD 54. In the embodiment, the mounting base 120, including PSD 54, can be preinstalled in the structure of the monolithic part 100 and aligned with the beam steering system 50, as will be understood by those skilled in the art.

In the O-LAMM system 10, the optical components 52-1, 52-2 can include prisms that function as a periscope such that the ends of the scan beam fan 51B are redirected onto the sensors 53-1, 53-2, respectively. When impinged by the light beams 52-1B and 52-2B, respectively, the sensors 53-1, 53-2 generate and send detection signals to the controller 40. The controller 40 can determine based on the received detection signals various parameters of the light beam scan 51B (including the light beams 52-1B, 52-2B). For instance, the controller can determine parameters such as, for example, the diameter of the scanned laser beam, the beam divergence, the fan angle, the beam power, and the detectability/visibility of the beam. Based on the detection signals, the controller 40 can determine fixed reference points for the beam scan fan 51B and compensate for any variations in PSD gain or offset due to thermal drift by updating drive signals to the beam steering system 50 to adjust parameters (and operation) of the beam steering device 151, thereby correcting the beam scan fan 51B (including beams 52-1B, 52-2B) to correct for any deviations in gain or line beam positioning. The drive signals can be generated, by the controller 40, to adjust, for example, the fan angle and the fan direction or location of the beam 50B (shown in FIG. 7).

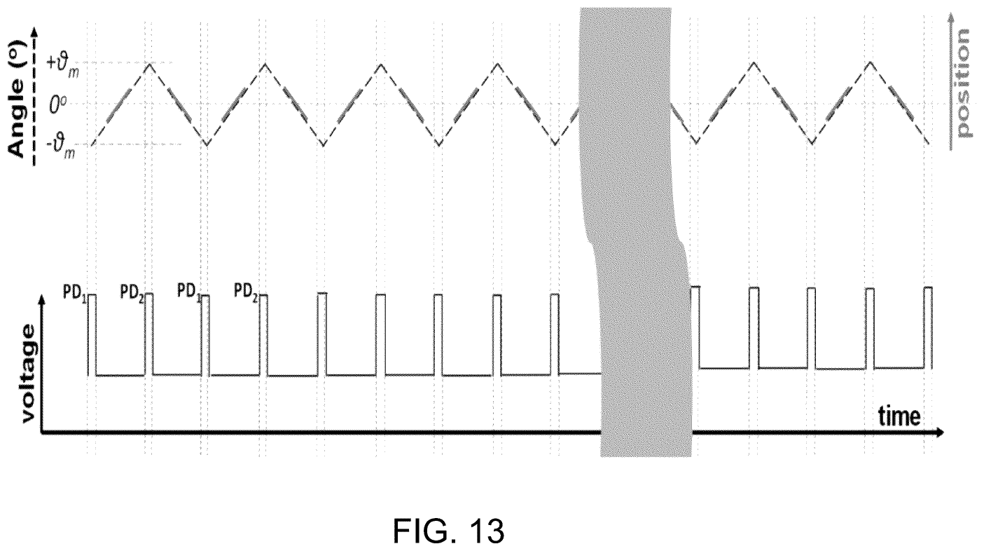

FIG. 13 shows a nonlimiting example of a sequential signal acquired by the controller 40 in the O-LAMM system 10 through the sensors 53-1, 53-2 (shown in the voltage-time chart) and the temporal changing of the angle of the beam steering mirror 51, depending on input voltage (shown in the angle-position chart). In the angle-position chart, the dashed line corresponds to the temporal changing of the angle of the beam steering device 51, and the sloid line corresponds to the time-dependent beam de-position measured by the PSD 54.

In various embodiments, the PSD measurements by the controller 40 (based on the sensor signals from the PSD 54) can be independent of the laser spot profile and intensity distribution, with the position being determined by controller 40 based on the centroid of the laser spot of the beam 51B. In certain embodiments, the resolution of the PSD 54 can reach down to 0.5 μm with sufficient incident light.

FIGS. 4 and 8-10 show various three-dimensional views of the O-LAMM system 10, including: FIG. 4 (a) shows a side perspective view of the O-LAMM system 10; FIG. 4(B) shows another side perspective view of the O-LAMM system 10; FIG. 4(C) shows a partial view of the O-LAMM system 10, with various parts omitted to better show certain optical components; FIG. 4(D) shows another partial, exploded view of the O-LAMM system 10; FIG. 4(E) shows another partial view of the O-LAMM system 10, with various parts omitted to better show certain optical components; FIG. 8 shows an exploded, three-dimensional perspective view of the O-LAMM system 10; FIG. 9 shows a partial view of a portion of the O-LAMM system 10, with the controller 40 and other components removed to illustrate an outer side of a sensor mounting base 150; and FIG. 10 shows a view of the O-LAMM system 10, with components removed to show an inner side of the sensor mounting base 150.

In the embodiment depicted in FIGS. 4-10, the O-LAMM system 10 combines the high effective resolution of the PSD 54 with the fixed reference of the feedback sensors 53-1, 53-2 to facilitate a higher resolution and overall accuracy than would be possible otherwise with either approach in isolation. In at least one implementation, the laser beam 50B emitted from the O-LAMM system 10 can encounter one or more retroreflectors, such as, for example, the retroreflector 3 (shown in FIG. 3). The light beam 50B will be retroreflected as the RRB beam back to the sensors 53-1, 53-2, and 54. The retroreflected laser signals RRB provide information for the angles of the scanning beam corresponding to the X coordinate and angle of the de-position corresponding to the Y coordinate. In the X coordinate sensing, the O-LAMM system 10 can set an initial time to at the arrival time of the signal to the controller 40, which is captured by the sensor 53-1 or 53-2. With the predetermined angular speed ω of the beam steering device 51, the angle θ for the beam steering device 51 at the time of the reflection can be calculated by the controller 40 as where Δt is the time interval between the initial time to and the time when the sending sensor 53-1 or 53-2 captures the retroreflected signal.

The O-LAMM system 10 can be configured to generate a laser line directed into beam steering device 51 to scan multiple targets at speeds of, for example, between 50 Hz and 500 Hz, such as, for example, at 100 Hz, using, for example, retroreflectors. In certain applications, the retroreflectors can include retroreflective cooperative markers on robotic end-effectors.

In at least one embodiment, the O-LAMM system 10 includes multiple O-LAMM units, including a first O-LAMM unit configured to capture X and Y locations upon laser-retroreflector interaction, and a second O-LAMM positioned at a preset location and distance, such that the controller 40, through triangulation with the second O-LAMM unit, determines the Z location. By networking multiple O-LAMM units, the O-LAMM system 10 can minimize blind spots within a target volume to provide a full specification six-degrees-of-freedom (6-DOF) high-precision position measuring device. The O-LAMM system 10 is well-suited for testing, inspection, positioning, deformation analysis, tracking, and other applications, delivering unmatched high-speed geometric data collection and accuracy.

When implementing the O-LAMM (or MO-LAMM) system 10 in environments that experience significant changes in ambient conditions, such as, for example, significant changes in temperature (for example, about −60° C. to +60° C.), pressure or humidity, the O-LAMM system 10 is able to compensate for any effects of such conditions over time to the amplitude or linearity of the scan pattern of the beam steering system 50, which might otherwise reduce the effective accuracy of the overall O-LAMM system. The instant disclosure provides a technological solution that, among other things, overcomes material changes in amplitude or linearity of the scan pattern of the beam steering system 51 over time, such as, for example, due to temperature changes. As discussed above, the O-LAMM system 10 employs, via the controller 40, spatial calibration obtained from temporal information measured by the sensors 53-1, 53-2, and 54.

In at least one embodiment of the O-LAMM system 10, the beam steering device 51 is a bidirectional galvo mirror and the retroreflected beam RRB is redirected to a polished rear surface of the galvo mirror through the optical components 55-57 (shown in FIG. 7), wherein the RRB beam is reflected onto one or more feedback optics, including the feedback sensors (FB PD) 53-1, 53-2, and the PSD 54. The position of the resulting laser dot on the PSD 54 is proportional to an angle of the galvo mirror 51 in real-time, at any given time. Therefore, a processed output voltage of the PSD 54 is proportional to the position of the laser dot on the PSD 54.

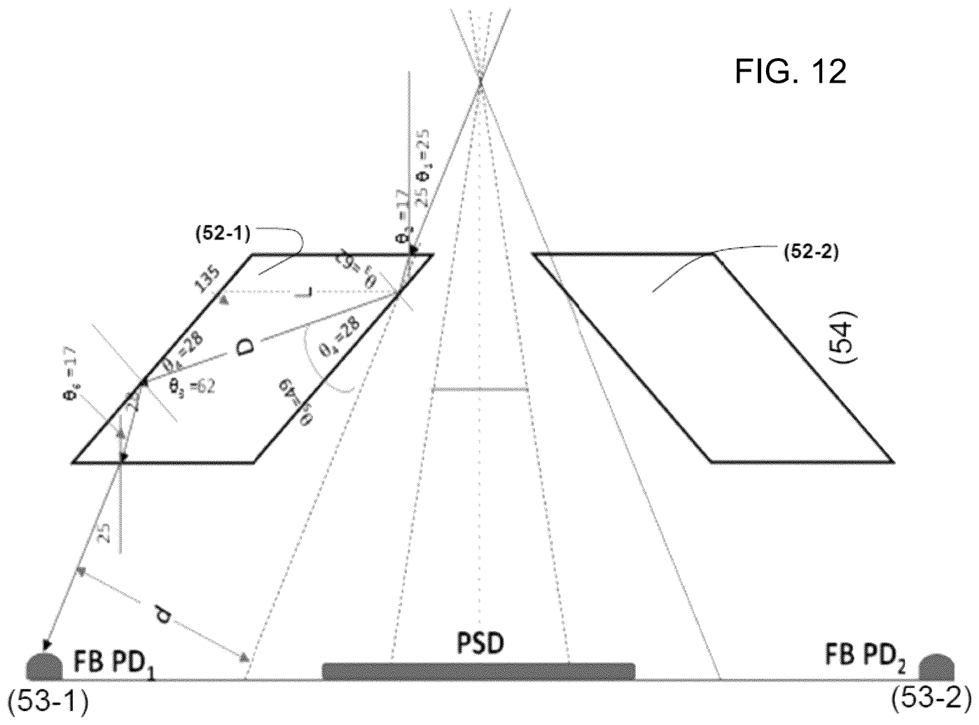

FIG. 12 shows a schematic diagram that illustrates operation and interaction of the optical components 52-1, 52-2, and sensors 53-1, 53-2, and 54 in correcting for inconstant angular speed and scanning frequency such as can result from significant changes in ambient conditions. By using a pair of a pair of rhomboid prisms for the optical components 52-1, 52-2, the full scanning range of the beam steering device 51 can be sensed. A rhomboid prism is a type of reflective prism that, effectively, acts as a pair of single mirrors and has a shape where its lateral displacement is equal to the length of the prism. The rhomboid prism has an angle of 45° between its long and short sides, and the length of the long side is √2 times that of the short side. This configuration enables the beam steering device 51 to reach the full scanning range as seen FIG. 12.

The O-LAMM system 10 can function as a lateral beam displacement apparatus. In the embodiment depicted in FIG. 12, the pair of rhomboid prisms 52-1, 52-2 are configured to shift the beam positions in the plane of PSD 54 and the FB PDs 53-1, 53-2 corresponding to the beam reflected at the angles of −θₘ and +θₘ of the beam steering device 51. The O-LAMM system 10 can also include a pair of mirrors configured to change the incident angle of the beam into the prisms 52-1, 52-2 in some configurations.

In an embodiment, the real beam applied in the O-LAMM system 10 can be a beam with a diameter of ˜2 mm and converging gradually while travelling to the plane of PSD 54. Referring to the ray diagrams in FIG. 12, because of the physical size of PSD 54 and FB PD 53-1, 53-2, a countable portion of the beam will be consumed in the inactive area of the sensors. The rhomboid prisms 52-1, 52-2 are included and applied to offset the beam. The deposed locations measured by the precisely positioned PSD 54 correspond to the deflected angles of the beam steering device 51. With a resolution set to 0.5 μm, and the rapid response time provided by the PSD 54, the controller 40 can calibrate and correct for errors caused by inconstant scanning speeds of the steering device 51.

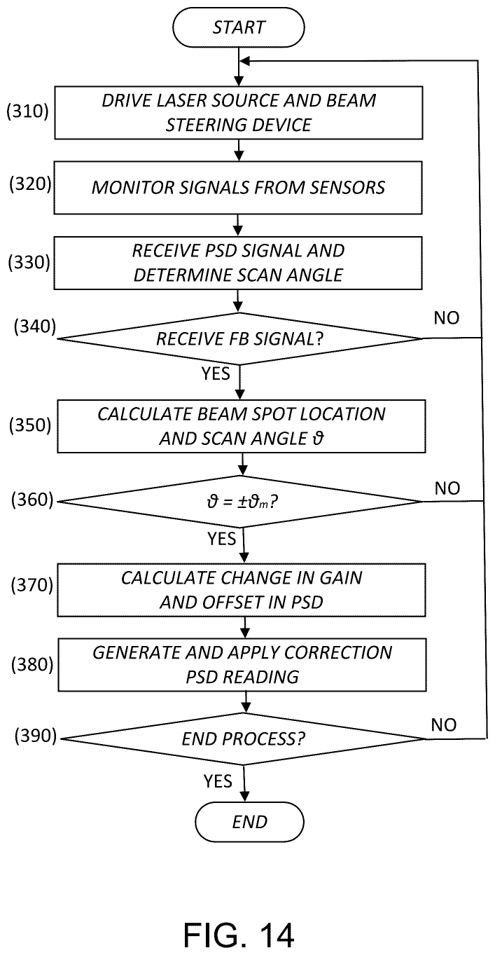

FIG. 14 shows an embodiment of a process that can be performed by the O-LAMM system 10. Referring to FIGS. 7, 12, and 14 contemporaneously, the controller 14 (e.g., the PCB control unit) generates and sends drive signals to operate the laser source 30 and the beam steering device 51 to scan a laser beam along a scan line that is perpendicular to a direction of the laser beam (Step 310). The controller 40 (for example, PCB control unit through a DAC and the ARM CPU, as described in US 2022/0326379) regulates the beam steering device 51 into different angles sequentially by applying a current signal to the device 51, such as, for example, a periodic triangular (or sinusoidal) signal.

As the light beam is scanned by the beam steering device 51, the controller 40 listens for any feedback detection signals from the sensors 53-1, 53-2 while monitoring for any position detection signals from the PSD 54 (Step 320). When the laser dot impinges on the PSD 54, the PSD 54 generates and sends, and the controller 40 receives, a PSD signal that can be used to determine a location of the laser dot and scan angle θ in real-time, as a function of time (Step 330). For instance, when the centroid dot of the beam deflected by the beam steering device 51 reaches the active area of the PSD 54, the centroid of the beam spot, which exactly corresponds to the scan angle of the beam steering device 51, is measured by the PSD 54 and the measurement sent to the controller 40 (for example, sent to the FPGA and CPU in US 2022/0326379), which then determines the laser dot location and scan angle θ based on the received measurement (Step 330).

As the laser beam travels along the scan line, the controller 40 continues to listen for any feedback signals from the sensors 53-1, 53-2 (Step 340), and, if a feedback signal is received from one of the sensors 53-1, 53-2 (YES at Step 340), the controller 40 determines the beam steering angle θ at the time it receives the feedback signal (Step 350), otherwise the process continues (NO at Step 340, then Steps 310 to 340). When a centroid of the laser beam dot impinges on the feedback sensor 53-1 (or 53-2) (FB PD₁ (or FB PD₂) in FIG. 12), the sensor 53-1 (or 53-2) sends a feedback (or detection) signal to the controller 40. Based on the speed value ω of the beam steering device 51 and time differential Δt, the controller 40 (for example, via the DAC and the ARM CPU described in the aforenoted and incorporated US 2022/0326379) can determine the precise location of the laser beam dot and the scan angle θ, in real-time, according to the relationship Θ=ω·Δt (Step 350).

Depending on whether the detection signal is received from the sensor 53-1 or sensor 53-2, the controller 40 determines the beam steering device 51 has rotated to an end of the predetermined scan pattern (YES at Step 360). For example, when the centroid of the laser beam dot is detected by the sensor 53-1, the controller 40 determines the laser beam has reached a first end (the negative end) of the scan pattern and a negative scan angle −θₘ is determined (for example, the negative maximum scanning angle shown in FIG. 13). When the centroid of the laser beam dot is detected by the sensor 53-2, the controller 40 determines the laser beam has reached a second end (the positive end) of the scan pattern and a positive scan angle +θₘ is determined (for example, the positive maximum scanning angle shown in FIG. 13). In either instance, the controller 40 determines the end of the scan pattern has been reached (YES at Step 360), otherwise (NO at Step 360) the beam steering device 51 can continue along its trajectory (Steps 310-360).

When the can pattern end is reached (YES at Step 360), the controller 40 calculates a gain and offset in the PSD based on the signals received from the PSD 54 and sensors 53-1, 53-2 (Step 370). For instance, once the beam steering devices rotates to ±θₘ, the controller 4 receives a feedback signal and, based on the most-recently received PSD signal, the controller 40 calculates the change in gain and offset within the PSD 54, for example, by comparing the maximum and minimum values of the PSD data against the fixed reference points of the two sensors 53-1, 53-2. These corrections can be applied by the controller 40 to the PSD reading (Step 390). The process 300 can continue to repeat (NO at Step 390, then Steps 310-380), until a determination is made to end the process (YES at Step 390).

A computer program product can be tangibly embodied in a non-transitory computer-readable storage medium (not shown), which can be contained in the controller 40. The computer program product can contain instructions that, when executed by a processor in the controller 40, perform one or more methods or operations, such as those included in this disclosure, including the process of FIG. 14. The controller 40 includes one or more processors and a memory.

The various embodiments discussed above can be mixed and matched as needed.

The terms “a,” “an,” and “the,” as used in this disclosure, means “one or more,” unless expressly specified otherwise.

The term “communication link,” as used in this disclosure, means a wired or wireless medium that conveys data or information between at least two points. The wired or wireless medium can include, for example, a metallic conductor link, a radio frequency (RF) communication link, an Infrared (IR) communication link, or an optical communication link. The RF communication link can include, for example, WiFi, WiMAX, IEEE 802.11, DECT, 0G, 1G, 2G, 3G, 4G, or 5G cellular standards, or Bluetooth. A communication link can include, for example, an RS-232, RS-422, RS-485, or any other suitable serial interface.

The terms “computer,” “computing device,” or “processor,” as used in this disclosure, means any machine, device, circuit, component, or module, or any system of machines, devices, circuits, components, or modules that are capable of manipulating data according to one or more instructions. The terms “computer,” “computing device” or “processor” can include, for example, without limitation, a processor, a microprocessor (μC), a central processing unit (CPU), a graphic processing unit (GPU), an application specific integrated circuit (ASIC), a general purpose computer, a super computer, a personal computer, a laptop computer, a palmtop computer, a notebook computer, a desktop computer, a workstation computer, a server, a server farm, a computer cloud, or an array or system of processors, μCs, CPUs, GPUs, ASICs, general purpose computers, super computers, personal computers, laptop computers, palmtop computers, notebook computers, desktop computers, workstation computers, or servers.

The term “computer-readable medium,” as used in this disclosure, means any non-transitory storage medium that participates in providing data (for example, instructions) that can be read by a computer. Such a medium can take many forms, including non-volatile media and volatile media. Non-volatile media can include, for example, optical or magnetic disks and other persistent memory. Volatile media can include dynamic random-access memory (DRAM). Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read.

Various forms of computer readable media can be involved in carrying sequences of instructions to a computer. For example, sequences of instruction (i) can be delivered from a RAM to a processor, (ii) can be carried over a wireless transmission medium, or (iii) can be formatted according to numerous formats, standards or protocols, including, for example, WiFi, WiMAX, IEEE 302.11, DECT, 0G, 1G, 2G, 3G, 4G, or 5G cellular standards, or Bluetooth.

The terms “including,” “comprising” and their variations, as used in this disclosure, mean “including, but not limited to,” unless expressly specified otherwise.

The term “transmission,” “transmit,” “sent” or “send,” as used in this disclosure, means the conveyance of data, data packets, computer instructions, or any other digital or analog information via electricity, acoustic waves, light waves or other electromagnetic emissions, such as those generated with communications in the radio frequency (RF) or infrared (IR) spectra. Transmission media for such transmissions can include coaxial cables, copper wire and fiber optics, including the wires that comprise a system bus coupled to the processor.

References in the disclosure to “one embodiment,” “an embodiment,” “an example embodiment,” or “example,” indicate that the embodiment described can include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Values expressed in a range format can be interpreted in a flexible manner to include not only the numerical values explicitly recited as the limits of the range, but also to include all the individual numerical values or sub-ranges encompassed within that range as if each numerical value and sub-range is explicitly recited.

The term “or” is used to refer to a nonexclusive “or” unless otherwise indicated. Unless indicated otherwise, the statement “at least one of” when referring to a listed group is used to mean one or any combination of two or more of the members of the group. For example, the statement “at least one of A, B, and C” can have the same meaning as “A; B; C; A and B; A and C; B and C; or A, B, and C,” or the statement “at least one of D, E, F, and G” can have the same meaning as “D; E; F; G; D and E; D and F; D and G; E and F; E and G: F and G; D, E, and F; D, E, and G; D, F, and G; E, F, and G; or D, E, F, and G.” A comma can be used as a delimiter or digit group separator to the left or right of a decimal mark; for example, “0.000,1″” is equivalent to “0.0001.”

In the methods described herein, the steps can be carried out in any order without departing from the principles of the invention, except when a temporal or operational sequence is explicitly recited. Furthermore, specified steps can be carried out concurrently unless explicit language recites that they be carried out separately. For example, a recited act of doing X and a recited act of doing Y can be conducted simultaneously within a single operation, and the resulting process will fall within the literal scope of the process. Recitation in a claim to the effect that first a step is performed, and then several other steps are subsequently performed, shall be taken to mean that the first step is performed before any of the other steps, but the other steps can be performed in any suitable sequence, unless a sequence is further recited within the other steps. For example, claim elements that recite “Step A, Step B, Step C, Step D, and Step E” can be construed to mean step A is carried out first, step E is carried out last, and steps B, C, and D can be carried out in any sequence between steps A and E (including with one or more steps being performed concurrent with step A or Step E), and that the sequence still falls within the literal scope of the claimed process. A given step or sub-set of steps can also be repeated.

Furthermore, specified steps can be carried out concurrently unless explicit claim language recites that they be carried out separately. For example, a claimed step of doing X and a claimed step of doing Y can be conducted simultaneously within a single operation, and the resulting process will fall within the literal scope of the claimed process.

Devices that are in communication with each other need not be in continuous communication with each other unless expressly specified otherwise. In addition, devices that are in communication with each other may communicate directly or indirectly through one or more intermediaries.

Although process steps, method steps, or algorithms may be described in a sequential or a parallel order, such processes, methods and algorithms may be configured to work in alternate orders. In other words, any sequence or order of steps that may be described in a sequential order does not necessarily indicate a requirement that the steps be performed in that order; some steps may be performed simultaneously. Similarly, if a sequence or order of steps is described in a parallel (or simultaneous) order, such steps can be performed in a sequential order. The steps of the processes, methods or algorithms described in this specification may be performed in any order practical.

When a single device or article is described, it will be readily apparent that more than one device or article may be used in place of a single device or article. Similarly, where more than one device or article is described, it will be readily apparent that a single device or article may be used in place of the more than one device or article. The functionality or the features of a device may be alternatively embodied by one or more other devices which are not explicitly described as having such functionality or features.

The subject matter described above is provided by way of illustration only and should not be construed as limiting. Various modifications and changes can be made to the subject matter described herein without following the example embodiments and applications illustrated and described, and without departing from the true spirit and scope of the invention encompassed by the present disclosure, which is defined by the set of recitations in the following claims and by structures and functions or steps which are equivalent to these recitations.

1. An apparatus for orthogonal laser metrology having one or more orthogonal laser metrology modules (O-LAMMs), the apparatus comprising:
a first monolithic structure that includes a first plurality of components preinstalled and aligned in the first monolithic structure, at least one of the first plurality of components comprising a bidirectional beam steering device; and
a second monolithic structure that includes a second plurality of components preinstalled and aligned in the second monolithic structure,
wherein:
the first monolithic structure has a first connecting portion;
the second monolithic structure has a second connecting portion;
the first monolithic structure and the second monolithic structure are each constructed to be aligned and adjoined to each other at an interface of the first connecting portion and the second connecting portion; and
the first plurality of components are preinstalled and optically aligned in the first monolithic structure such that when the first monolithic structure and the second monolithic structures are adjoined to each other at said interface, the second plurality of components are aligned with the first plurality of components.

2. The apparatus of claim 1, wherein at least one of the first connecting portion and the second connecting portion includes a bevel portion.

3. The apparatus of claim 2, further comprising an adjustable support that includes at least one side having a surface that is constructed to match and engage the bevel portion for three-point support.

4. The apparatus of claim 2, wherein the at least one of the first connecting portion and the second connecting portion further includes a planar surface formed at an angle with the bevel portion.

5. The apparatus of claim 1, wherein the first monolithic structure comprises a first support member and a second support member.

6. The apparatus of claim 5, wherein each of the first plurality of components are preinstalled and connected to both the first support member and the second support member, and wherein the first plurality of components comprise at least one of a mirror, a lens, a prism, a feedback sensor device, a position sensor device, and a beam steering device.

7. The apparatus of claim 6, wherein:
the first support member includes a first plurality of pin holes;
the second support member includes a second plurality of pin holes;
each of the first plurality of components has a first pin and a second pin; and
each of the first plurality of components is connected to the first support member at its first pin and connected to the second support member at its second pin.

8. The apparatus of claim 7, wherein each of the first plurality of pin holes are aligned with a corresponding one of the second plurality of pin holes.

9. The apparatus of claim 1, wherein the first plurality of components and the second plurality of components comprise at least one of a mirror, a lens, a prism, a collimator, a feedback sensor device, a position sensor device, a beam steering device, and a coherent energy source.

10. The apparatus of claim 1, wherein:
at least one of the first plurality of components comprise a mirror configured to receive a retroreflected beam of coherent energy and redirect the retroreflected beam of coherent energy to a surface of the bidirectional beam steering device; and
at least one of the second plurality of components is configured to receive the beam of coherent energy and direct it to another surface of the bidirectional beam steering device.

11. The apparatus of claim 1, wherein:
the first monolithic structure comprises a pair of feedback sensors and position sensing sensor that are preinstalled and aligned with the first plurality of optical components; and
each of the pair of feedback sensors is configured to detect an end of a beam scan pattern and the position sensing sensor is configured to detect a centroid of laser dot.

12. A computer-implemented method for orthogonal laser metrology using a monolithic structure having one or more orthogonal laser metrology modules (O-LAMMs), the method comprising:
scanning a laser beam, by a beam steering device, along a first direction in a spatial plane;
receiving, from a feedback sensor, a feedback signal indicating an end of scan along the first direction in the spatial plane;
scanning the laser beam, by the beam steering device, along a second direction in the spatial plane;
receiving, from a position sensor device (PSD), a beam position signal indicating a beam spot centroid of the laser beam along a line in the spatial plane;
calculating, by a processor, the beam spot centroid location based on at least one of the beam position signal and the feedback signal; and
calculating, by the processor, a correction based on the beam position signal and the feedback signal; and
applying, by the processor, the correction to the beam position signal to provide a real-time location of the beam spot centroid.

13. The method of claim 12, the method further comprising:
receiving, from a second feedback sensor, a second feedback signal indicating a second end of scan along the second direction in the spatial plane,
wherein calculating the correction is based on the beam position signal and the feedback signal and the second feedback signal.

14. The method of claim 12, wherein the correction comprises a change in gain or offset in the position sensor device (PSD).

15. The method of claim 12, the method further comprising:
calculating, by the processor, a scan angle of the beam steering device based on at least one of the beam position signal, the feedback signal, and the second feedback signal.

16. The method of claim 12, wherein the beam steering device comprises a bidirectional beam steering mirror.

17. The method of claim 12, wherein at least one of the first feedback sensor and the second feedback sensor comprises a photodiode.

18. The method of claim 17, wherein the photodiode is optically aligned with a rhomboid prism.

19. The method of claim 12, wherein the position sensor device (PSD) comprises a line sensor.

20. The method of claim 19, wherein the position sensor device (PSD) is optically aligned with a split aperture configured to block light other than light indicating the beam spot centroid of the laser beam along the line in the spatial plane.
